(19) United States
(12) Patent Application Publication
(10) Pub. No.: US 2020/0189896 A1
(43) Pub. Date: Jun. 18, 2020

(54) CONTAINER TREATMENT PLANT FOR TREATING CONTAINERS

(71) Applicant: KRONES AG, Neutraubling (DE)

(72) Inventors: Stefan RAITH, Pfatter (DE); Wolfgang HAHN, Neutraubling (DE); Andreas HACK, Dingolfing (DE); Florian GELTINGER, Donaustauf (DE); Markus ZOELFL, Mettenberg (DE)

(21) Appl. No.: 16/621,666

(22) PCT Filed: Feb. 22, 2018
(86) PCT No.: PCT/EP2018/054334

§ 371 Date: Dec. 11, 2019

(30) Foreign Application Priority Data
Jun. 12, 2017 (DE) 10 2017 209 838.4

(51) Int. Cl. B67C 3/22; B25J 5/00; B25J 9/00; B25J 15/00; B67B 3/00

(52) U.S. Cl. CPC B67C 3/22; B25J 5/007; B67C 2003/221; B25J 15/0066; B67B 3/00; B25J 9/0084

(57) ABSTRACT

The invention relates to a container processing installation (100) for processing containers such as bottles, comprising at least one container processing machine (120, 130) and a mobile collaborating robot (101) that is designed for robot-robot interaction and/or robot-human interaction, wherein said collaborating robot (101) is designed to cooperate during exchange of a component of the container processing machine. The invention also relates to a corresponding method for exchanging a component of a container processing machine of a container processing installation.

The present invention relates to a container treatment plant for treating containers, such as bottles, according to claim 1 and to a method of exchanging a component of a container treatment machine of a container treatment plant in the beverage-processing industry according to claim 9.

### Prior Art

Container treatment plants comprising one or a plurality of container treatment machines are known from the prior art.

Likewise, it is known that these machines have to be modified in the case of a change of formats, e.g. when changing from a first bottle size to a second bottle size. Usually, machine components are exchanged for this purpose. For example, the blow molds of a blow molding machine may be exchanged.

Such format changes are usually executed manually, i.e. they are executed by an operator of the machine. This entails a considerable expenditure of time and physical strain on the part of the operator.

### Task

It follows that, taking the known prior art as a basis, the technical task to be solved is to provide a container treatment plant in which a component can be exchanged with the least possible expenditure of time and without any difficulties for the operator.

### Solution

This task is solved by the container treatment plant according to claim 1 and the method of exchanging a component of a container treatment machine of a container treatment plant according to claim 10 as well as the system of container treatment plants according to claim 14. Advantageous further developments of the present invention are specified in the subclaims.

The container treatment plant disclosed by the present invention and used for treating containers, such as bottles, comprises at least one container treatment machine and a mobile, collaborating robot configured for robot-robot interaction and/or for robot-man interaction, wherein the collaborating robot is configured to cooperate in exchanging a component of the container treatment machine.

A collaborating robot should be understood to mean all the devices controlled by a computer or a processing unit, which are equipped e.g. with a tool or with similar means for interaction with the surroundings and are able to interact with humans or with other robots in such a way that they cooperate with the human or with the robot so as to fulfil a specific task, e.g. in component exchange operations, and either carry out substeps of such a process themselves or assist in such substeps in a supporting capacity. For example, the collaborating robot may lift a component that is too heavy for an operator, while the operator maneuvers the component to the correct position. In particular, the term “collaborating robot” should be understood to mean the already known COBOTs.

The cooperation of the collaborating robot in exchanging a component of the container treatment machine should be understood such that the collaborating robot either executes at least a substep of the exchange of the component or at least participates in such a substep and executes it in cooperation with a human or with some other robot. The cooperation of the robot is here not limited to simultaneous cooperation with an operator/human in such a way that both the operator and the robot execute tasks at the machine at the same time—together or independently of one other. The cooperation may also comprise preparatory or subsequent steps, which can be executed not only while the machine is standing still, but also during production. These steps comprise exemplarily, but not exclusively, the provision of (new or additional) materials, change parts, tools for setting-up as well as the disposal of (old or used) materials, change parts, tools, etc. after setting-up. It goes without saying that these preparatory steps and/or subsequent steps can also be performed at the machine while an operator is present and is already executing other tasks. Furthermore, these steps can also be performed in the complete absence of an operator and they do not under any circumstances imperatively require cooperation with a possibly present operator.

The term “mobile”, collaborating robot should here be understood as meaning that the robot in its entirety is not limited to a specific location, but can be moved from one location to another e.g. in a factory hall. This movement can take place either autonomously, i.e. the robot can move independently from one location to another, essentially without further monitoring or control by an operator. Or the movement of the robot can be controlled by an operator.

The use of such mobile collaborating robots allows a time-efficient exchange of components, whereby it will be possible to reduce the amount of human work, or at least the amount of manpower required on the part of the operator and the actions to be performed in component exchange operations. At the same time, the error-proneness of component exchange operations can be reduced in an advantageous manner, since at least a few substeps of the component exchange are executed by a robot.

According to an embodiment, the collaborating robot comprises a safety system, which is configured to continuously determine a risk of collision with a human being in the surroundings of the robot, so as to control the movements of the robot such that the risk of collision will be minimized. The risk of damage to other robots and in particular the risk of injury to operators cooperating with the collaborating robot can be minimized in this way.

According to a further development of this embodiment, the robot does not comprise any separating protective device. A separating protective device are, for example, protective walls that delimit the movement area of the robot from the surroundings, so that an operator cannot inadvertently enter this movement area. If these protective devices can be dispensed with, the collaborating robot can interact directly with an operator or some other robot, so that collaboration in component exchange operations can be made even more efficient.

According to a further embodiment, the container treatment plant comprises a second container treatment machine, the collaborating robot being movable between the container treatment machine and the second container treatment machine. Hence, it is no longer necessary to separately provide at each container treatment plant all the robots necessary for exchanging a component, but robots that are required e.g. at each container treatment machine for exchanging a component can be made available to all container treatment machines on the basis of this embodiment and the acquisition costs of the system can be reduced nevertheless.

In addition, the robot may comprise a robot arm with a tool for interacting with a container treatment machine. This tool may, for example, be configured in the form of a clamp, a gripper or a screwdriver or the like and can be used by the robot e.g. for holding a component of the container treatment machine or for detaching it from the latter or for attaching it thereto.

According to a further development of this embodiment, the collaborating robot comprises a tool changing system by means of which the tool of the robot can be exchanged for some other tool carried along in the tool changing system. For example, the tool changing system may be configured as a box for different tools, and the robot may be configured to deposit one of its tools in this box and remove another tool and use it instead of the first tool. For exchanging the tools of the robot, the robot may also comprise or have assigned thereto an additional robot arm, which is configured to remove a tool from the robot and replace it by one from the tool changing system.

It follows that the collaborating robot becomes even more flexible in use and can be used advantageously at different container treatment machines of the container treatment plant also for different purposes.

Furthermore, the collaborating robot may be arranged on a movable platform. Components of the robot can thus be supported (on the platform) with the highest possible stability and moving the collaborating robot in its entirety can simultaneously be realized by means of the platform.

According to a further development of this embodiment, the movable platform forms, together with a guide configured as a stator and extending through the container treatment plant, a linear drive. Linear drives are energy-efficient and at the same time very precisely controllable, so that the position of the collaborating robot can be adjusted flexibly and at the same time with high accuracy.

Also other possibilities of driving are imaginable, which, depending on the respective requirements, can be implemented in an advantageous manner. For example, dead reckoning (also odometry), track guidance with continuous guidelines, LIDAR systems, grid navigation, laser navigation, 2D and 3D laser scanners in connection with features of the surroundings (2D or 3D), 2D cameras or 3D cameras in connection with image recognition software as well as GPS systems, in particular indoor GPS systems, may preferably be used. In these cases, the robot may advantageously be equipped with a drive of its own, in particular an electric drive.

According to an embodiment, the mobile, collaborating robot is configured as a humanoid robot and comprises two arms and/or two legs configured to cooperate in activities performed by the robot. Interaction with an operator can thus be realized even more effectively and also additional protective measures, such as protective walls, can be dispensed with.

The method disclosed by the present invention and used for exchanging a component of a container treatment machine of a container treatment plant in the beverage-processing industry comprises cooperation of a mobile, collaborating robot, which is configured for robot-robot interaction and/or for robot-man interaction, in exchanging the component. The effort required on the part of the operator can thus be reduced and the error proneness in component exchange operations can be reduced as well.

According to an embodiment, the collaborating robot continuously determines, by means of a safety system, a risk of collision with a human being in the surroundings of the robot and the movement of the robot is controlled such that the risk of collision will be minimized. The risk of injury to the operator interacting with the collaborating robot can thus be reduced.

According to an embodiment, the collaborating robot executes or participates in at least one of the following activities: picking up components at a specific position, moving components to a specific position, establishing and/or loosening fastenings of components, coupling and/or decoupling of media lines and/or cables and/or supply lines and executing adjustment work. These activities include either moving heavy objects and/or they require considerable accuracy. Robots are particularly suitable for both tasks.

In addition, it may be provided that, before and/or during the exchange of a component of the container treatment machine, the collaborating robot exchanges a tool at the collaborating robot for some other tool carried along in a tool changing system.

The collaborating robot can thus also be used flexibly for exchanging different components of container treatment machines.

The present invention also provides a system comprising at least two container treatment plants, each comprising at least two container treatment machines for treating containers, wherein the system comprises at least one mobile, collaborating robot, which is configured for robot-robot interaction and/or for robot-man interaction, the collaborating robot being configured to cooperate in exchanging a component of a container treatment machine of one of the container treatment plants and to move independently between the container treatment machine of the container treatment plant and another container treatment machine of the other container treatment plant.

According to an embodiment, the container treatment plants are configured as beverage filling plants and comprise each at least one filler for filling containers with a product and a capper arranged downstream of the filler (i.e. downstream, when seen in the direction of transport or direction of movement of the containers in the plant) and used for closing the containers.

### BRIEF DESCRIPTION OF THE FIGURES

FIG. 1 shows a schematic representation of an embodiment of a container treatment plant,

FIG. 2a shows a detailed schematic view of a collaborating robot according to an embodiment,

FIG. 2b shows a detailed schematic view of a collaborating robot in an embodiment configured as a humanoid robot.

### DETAILED DESCRIPTION

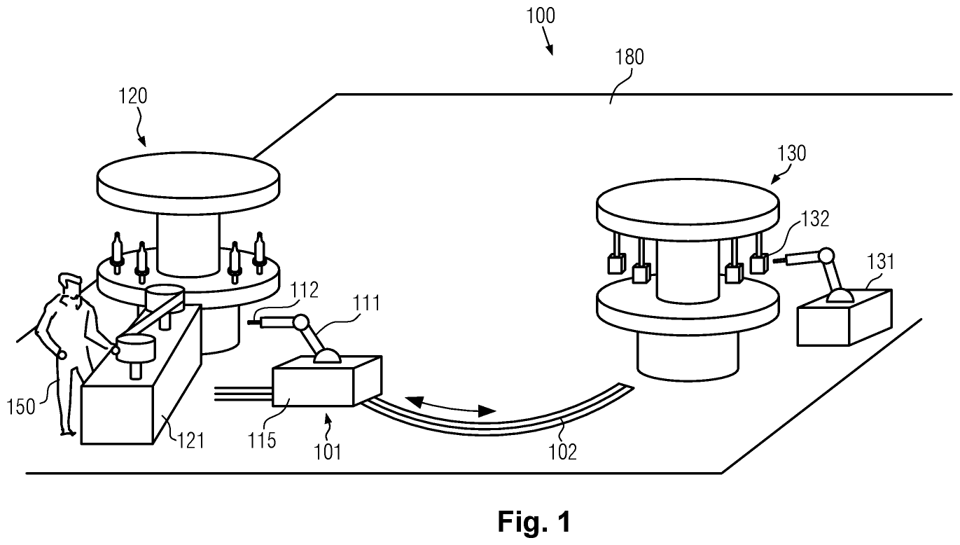

FIG. 1 shows a schematic view of a container treatment plant 100 according to an embodiment. In the embodiment shown here, the container treatment plant is arranged e.g. in a factory hall 180 and comprises two container treatment machines 120 and 130. In the present embodiment, the container treatment machine 120 is configured as a labeling machine with a labeling unit 121 assigned thereto and the container treatment machine 130 is configured as a blow molding machine having blow molds 132 assigned thereto.

These exemplary embodiments are not mandatory and the container treatment plant 100 may also comprise completely different container treatment machines and also different numbers of container treatment machines (e.g. only one or more than two).

In addition, also embodiments are comprised, in which not only one container treatment plant but a plurality of container treatment plants is provided. The latter may comprise, at least partially, identical container treatment machines. For example, a first container treatment plant may comprise a blow molding machine, a filler, a capper and a labeling machine, whereas the second container treatment plant comprises a blow molding machine, a filler, a capper and a printing machine for printing on the containers.

Furthermore, in the embodiment shown in FIG. 1, the container treatment machine 130 has assigned thereto a stationary robot 131, which may be configured for manipulating components of the container treatment machine 130. This robot may, for example, exchange blow molds of the container treatment machine 130 configured as a blow molding machine.

In the situation shown in FIG. 1, however, an operator 150 may carry out jobs at the container treatment machine 120. For example, he may replace an empty label roll on the labeling unit 121.

The robot 131 and the operator 150 are here only shown exemplarily in order to illustrate various situations described hereinafter. For example, an additional operator may be provided instead of the robot 131 or a plurality of operators and/or robots may work in common at a container treatment machine.

According to the present invention, the container treatment plant 100 further comprises a mobile, collaborating or collaborative robot 101. In the embodiment shown here, this robot may be arranged e.g. on a movable platform 115, which can preferably be moved through the entire factory hall 180. In the following, the platform may be understood as part of the robot 101.

Since the collaborating robot 101 is usually intended to be used in connection with one or a plurality of container treatment machines 120 and 130, the robot 101 may also be arranged such that it is movable along a guide 102. In particular, the platform and the guide 102 may define together a linear motor in such a way that the guide 102 forms the stator of this linear motor. Also other structural designs for moving the robot are imaginable. In particular, the robot may have a drive of its own (preferably an electric drive with at least one electric motor) and may also be equipped with a navigation system of its own, so that it can essentially move independently. What can preferably be used is dead reckoning (also odometry), track guidance with continuous guidelines, LIDAR systems, grid navigation, laser navigation, 2D and 3D laser scanners in connection with environmental features (2D or 3D), 2D cameras or 3D cameras in connection with image recognition software as well as GPS systems, in particular indoor GPS systems.

The power supply of the robot can be provided by means of one or more energy storage units, preferably accumulators. The latter may either be charged at a central charging station when the robot is not in use, or they may be supplied with power during operation by means of inductive processes, e.g. at each container treatment machine. In addition, empty accumulators may also be exchanged by the robot itself for a fully charged accumulator, so that downtimes of the robot can be kept short and the robot will, to the highest possible degree, always be ready for use.

In addition, reference should be made to the fact that the robot is not limited to a movement between container treatment machines of a single container treatment plant. As has already been explained hereinbefore, also a plurality of container treatment plants may be provided. In this case, the robot may also move between container treatment machines of the various container treatment plants. The necessary devices for navigation and possibly also the independent drive correspond here to those used in the case of a movement between container treatment machines of a single container treatment plant.

According to a particularly preferred embodiment, a collaborating robot may be provided for each type of container treatment machine, the robot being specially adapted to the tasks to be solved in the case of the type in question. For example, a first type of robot may be equipped with special tools for work at blow molding machines, whereas another type of robot may be equipped with other tools for work at labeling machines.

The robot may be provided with a robot arm 111 having at least one tool 112 attached to one end thereof. The tool may, for example, be a gripper or a similar mechanism for holding objects, in particular components of the container treatment machine.

According to the present invention, the collaborating robot 101 may be able to assist the operator at least in exchanging a component at the container treatment machine 120 (independently of its specific design as a labeling machine). For example, the collaborating robot 101 may disconnect connections at the labeling unit, so that the operator can take the empty label roll. Alternatively, the operator may loosen the connections (e.g. screw connections) while the collaborating robot holds the label roll to prevent it from dropping onto the operator, thus minimizing the risk of injury of the latter.

Additionally or alternatively, the collaborating robot 101 may also cooperate e.g. with the robot 131 in exchanging a component at the container treatment machine 130 (e.g. a blow mold).

In principle, the collaborating robot 101 is configured such that it is not provided with separating protective devices, such as partitions, nor has it assigned thereto such protective devices at a working position at which it participates in exchanging a component at a container treatment machine. The working area of the collaborating robot (e.g. of the robot arm 111) is therefore accessible at any time for an operator 150 and also for other robots 131. This allows the operator and other robots to actually interact with the collaborating robot and an effective changeover of container treatment machines can be ensured.

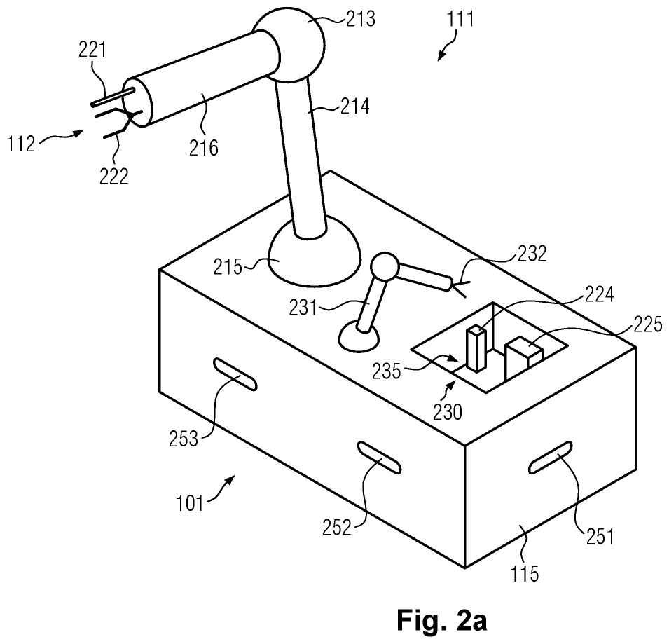

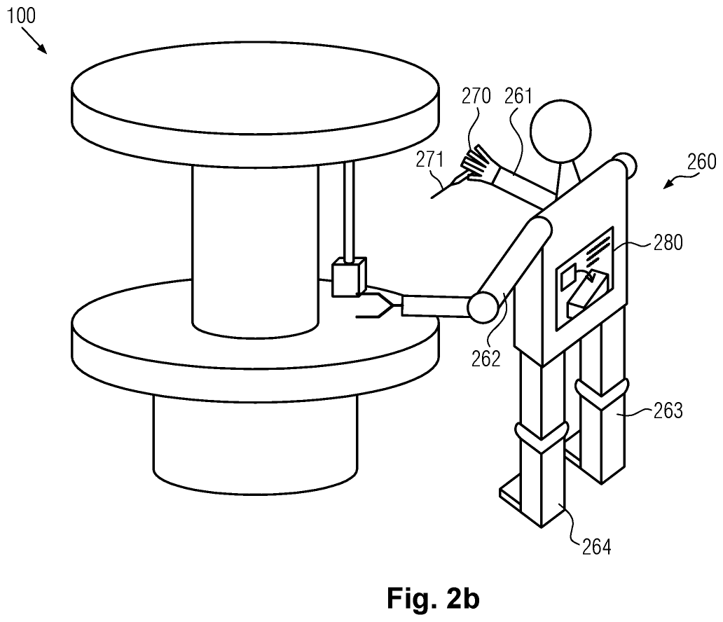

However, in order to reduce the risk of injury, in particular of humans cooperating with such a collaborating robot, a safety system may be provided, which minimizes the risk of collision with an operator by controlling the movement of the collaborating robot 101, as explained in more detail in FIG. 2.

FIG. 2a shows a more detailed schematic representation of the collaborating robot 101. As has already been described with reference to FIG. 1, the robot may comprise a platform 115, with the aid of which the robot can be placed on the guide 102 according to FIG. 1. Alternatively, the platform may also be equipped with wheels and a steering system as well as with a drive of its own, for independent navigation through a factory hall or for navigation that is at least partially controlled by an operator. For this purpose, the robot may also have an integrated navigation system, which allows the control unit of the robot to at least determine the relative position of the robot.

The platform may also accommodate a part of or all of the control electronics as well as the power supply of the robot.

In addition, the platform may have provided thereon or therein several sensors 251 to 253, which may form part of the safety system with which the robot 101 determines the risk of collision with an operator close to the robot 101 and controls its movements such that the risk of collision with the operator (and thus the risk of injury) will be minimized to the highest possible extent. This can be done autonomously by the robot 101 or the control electronics provided in the robot or also in interaction with other control units of the container treatment plant. The sensors may also act as part of the above-mentioned navigation system, so as to allow the robot to determine its position and move e.g. through the factory hall 180.

In addition, the robot 101 may comprise a robot arm 111 arranged e.g. on the platform 115. The robot arm may be formed by a plurality of joints 213 and 215 and a plurality of arm segments 214 and 216. The two joints and the two arm segments shown here are not mandatory. The robot arm may also consist of only one joint and one arm segment or two joints and one arm segment as well as of a plurality of joints and a plurality of arm segments.

In any case, the robot comprises one or a plurality of tools 112. These tools may comprise a screwdriver 121 and a gripper 222, as is here shown exemplarily. Fundamentally, the robot arm 111 may have a front area, in which mounting devices for a large number of different tools are arranged. These may e.g. be openings with threads or click connections. Furthermore, also connections for supplying attached tools with power or control electronics may be provided in this area.

It will be particularly advantageous when the tools of the robot 101 can be exchanged, in particular exchanged quickly. It is particularly preferred here, when the robot has a tool changing system 230. This tool changing system may be formed by a tool storage unit 235 and a robot arm assigned to this tool storage unit or, quite generally, by a robot 231 having in particular a gripping element 232. The tool storage unit 235 may have arranged therein a plurality of tools 225 and 224, which can be removed by the robot 231 and attached to the robot arm 111. To this end, the robot 231 may be configured such that, interacting with the robot arm (or a corresponding other embodiment of element 111), it will be able to remove a tool 221 or 222 mounted on the robot arm 111, deposit it in the tool assortment 235, and take a tool from the tool assortment 235 and mount it on the robot arm 111. According to a particularly preferred embodiment, the robot 231 is also configured to establish connections which may have to be established between a tool attached to the robot arm 111 and the robot arm itself (e.g. control electronics or fastenings).

Fundamentally, the collaborating robot 101 equipped in this way can perform a wide range of activities in connection with an exchange of components or the general retooling of container treatment machines. This includes, in particular, picking up and holding as well as transporting components, such as blow molds, the exchange of fittings or components, not only at the individual container treatment machines, but, if necessary, also on transport devices and packaging machines. Likewise, lines or connections can be disconnected or closed by the robot and positioning or setting work, in particular adjustment work, can be carried out.

As has already been mentioned, the robot has a safety system that can be used to minimize the risk of collision with an operator or with some other robot. The safety system (represented in FIG. 2a by the sensors 251 to 253) may comprise e.g. radar systems or LIDAR systems. Additionally or alternatively, also one or a plurality of cameras, in particular 3D cameras, may be used. Contact sensors are also an option here. Additionally or alternatively, some of the sensor systems described may also be used to allow a freely movable robot (which, for example, can move on rollers on the floor of the factory hall 180) to navigate within the factory hall 180.

FIG. 2b shows a further preferred embodiment of a mobile robot according to the present invention. According to this embodiment, the robot 260, which is here a “humanoid” robot, is preferably provided with two arms 261, 262 and two legs 263, 264 or at least with two arms (e.g. two robot arms as described in FIG. 2a with reference numeral 111). The arms and legs may preferably all be used together to execute a specific task. For example, the arms may advantageously be used to hold a comparatively large component that may be too heavy for a human and to move it to a specific location using the legs or to position the component.

The arms 261 and 262 may be configured analogously to the robot arm 111 and may also have tools, which are described in this context in FIGS. 1 and 2a and which can be exchanged, if necessary.

Alternatively or additionally, one of the arms or both arms may provided with a robot hand 270, as shown in FIG. 2b exemplarily for the arm 261. The robot is preferably equipped with a control unit (computer or the like), which allows the robot hand 270 to be controlled approximately according to the movement of a human hand. The robot hand 270 may be equipped with a plurality of controllable actuators (electric motors, in particular positioning drives) in order to move individual limbs of the robot hand 270 as independently as possible.

In particular, the robot hand may be configured to guide and operate tools that can also be used by a human. For example, the robot hand 270 can grip a screwdriver 271 and use it to tighten or loosen a screw. The tools used for mounting machine parts or forming parts can thus be used by both a human operator and the robot, and this can considerably simplify the cooperation between man and robot.

In order to simplify the interaction even more, displays 280 and/or voice output may also be used with all the robots described so far, with the help of which an operator present in the vicinity of the robot can be informed e.g. about the activities carried out by the robot.

In addition, the operator can interact with the robot via these devices, e.g. by operating the display 280 configured as a touch screen (alternatively, the display may also have associated therewith a keyboard or a similar device) or by means of voice control. The robot may also assist the operator in the activities to be executed by the latter, by outputting, with the aid of the display or voice output, information for the operator, the information concerning e.g. certain steps for retooling the machine. Also a video may be played on the display or a user manual may be displayed, depending on the kind of activity to be executed by the operator and the kind of component that may be involved.

In order to allow the robot to work as independently as possible, the components or forming parts to be processed by the robot may be provided with markings, e.g. RFID tags, and the robot may be able to recognize these making use of a suitable device (in the case of the present example an RFID sensor or reader).

In order to guarantee that, when the robot has to carry out activities on a container treatment machine, it will have the necessary components and, if necessary, also tools at its disposal, the operator may either be instructed to provide them or, preferably, a driverless transport system may be provided, which, with the aid of automatic trolleys or other equipment, transports the required parts, workpieces or machine components at the right time to the respective container treatment machine or also supplies replaced components of a machine to an (external) storage facility. While the previous embodiments have all been described with a floor-supported collaborating robot 101, also an arrangement on the walls or on the ceiling of a factory hall will be possible, especially when the embodiment of the robot is configured such that it comprises a platform interacting with a guide 102 (cf. FIG. 1 in this respect), thus allowing the robot to move, so that the floor of the factory hall can be made fully accessible to operators.

In principle, the control of the robot or of all the robots in one or in a plurality of container treatment plants can be ensured by a central control (computer, server, etc.), so that individual control units, which are separately assigned to each robot, can be dispensed with. Alternatively, the robot may also be able to identify the surroundings by means of suitable sensors (e.g. cameras) and to autonomously derive tasks in dependence thereon, which it will then execute preferably again independently/autonomously.

1. A container treatment plant for treating containers, comprising:
at least one container treatment machine; and
a mobile, collaborating robot configured for robot-robot interaction and/or for robot-man interaction, wherein the collaborating robot is configured to cooperate in exchanging a component of the at least one container treatment machine.

2. The container treatment plant according to claim 1, wherein the collaborating robot comprises a safety system, which is configured to continuously determine a risk of collision with a human being in a surroundings of the collaborating robot and to control movement of the collaborating robot such that the risk of collision is minimized.

3. The container treatment plant according to claim 2, wherein the collaborating robot does not comprise any separating protective device.

4. The container treatment plant according to claim 1, wherein the at least one container treatment machine includes a first container treatment machine and a second container treatment machine, wherein the collaborating robot is movable between the first container treatment machine and the second container treatment machine.

5. The container treatment plant according to claim 1 wherein the collaborating robot comprises a robot arm with a tool for interacting with the at least one container treatment machine.

6. The container treatment plant according to claim 5, wherein the collaborating robot comprises a tool changing system by means of which the tool of the collaborating robot can be exchanged for some other tool carried along in the tool changing system.

7. The container treatment plant according to claim 1, wherein the collaborating robot is arranged on a movable platform.

8. The container treatment plant according to claim 7, wherein the movable platform forms, together with a guide configured as a stator and extending through the container treatment plant, a linear drive.

9. The container treatment plant according to claim 1, wherein the mobile, collaborating robot is configured as a humanoid robot and comprises two arms and/or two legs configured to cooperate in activities performed by the robot.

10. A method of exchanging a component of a container treatment machine of a container treatment plant in the beverage-processing industry, comprising:
exchanging the component of the container treatment device via a mobile, collaborating robot configured for robot-robot interaction and/or for robot-man interaction in exchanging the component of the container treatment machine.

11. The method according to claim 10, wherein, by means of a safety system, the collaborating robot continuously determines a risk of collision with a human being in a surroundings of the collaborating robot and movement of the collaborating robot is controlled such that the risk of collision is minimized.

12. The method according to claim 10, wherein the collaborating robot executes or participates in at least one of the following activities: picking up components at a specific position, moving components to a specific position, establishing and/or loosening fastenings of components, coupling and/or decoupling of media lines and/or cables and/or supply lines, executing adjustment work.

13. The method according to claim 10, wherein, before and/or during the exchange of a component of the container treatment machine, the collaborating robot exchanges a tool at the collaborating robot for some other tool carried along in a tool changing system.

14. A system, comprising:
at least two container treatment plants, each of the at least two container treatment plants comprising at least two container treatment machines for treating containers, wherein the system comprises at least one mobile, collaborating robot, which is configured for robot-robot interaction and/or for robot-man interaction, the collaborating robot being configured to cooperate in exchanging a component of a container treatment machine of one of the container treatment plants and to move independently between the container treatment machine of the container treatment plant and another container treatment machine of the other container treatment plant.

15. The system according to claim 14, wherein the container treatment plants are configured as beverage filling plants and each of the container treatment plants comprising at least one filler for filling containers with a product and a capper arranged downstream of the filler and used for closing the containers.

16. The container treatment plant according to claim 1, wherein the containers are bottles.
